(19) United States
(12) Patent Application Publication
(10) Pub. No.: US 2026/0287069 A1
(43) Pub. Date: Sep. 24, 2026

(54) DUAL SEAT ASSEMBLY FOR BIDIRECTIONAL GATE VALVE SEALING

(71) Applicant: Scott E. Linder, Montgomery, TX (US)

(72) Inventor: Scott E. Linder, Montgomery, TX (US)

(21) Appl. No.: 19/572,769

(22) Filed: Mar. 19, 2026

Related U.S. Application Data
(60) Provisional application No. 63/774,100, filed on Mar. 19, 2025.

(51) Int. Cl. F16K 3/20

(52) U.S. Cl. CPC F16K 3/207

(57) ABSTRACT

A gate valve assembly comprises a valve body defining a flow bore and a gate opening, a gate movable between open and closed positions, and a pair of seat assemblies on opposite sides of the gate. Each seat assembly comprises an inner seat configured to engage the gate and seal against the valve body, an outer seat positioned radially outward and configured to engage the gate and seal against the valve body, and a spring biasing the inner seat toward the gate. The inner and outer seats operate independently such that when the gate is closed and upstream pressure is applied, the inner seat on the upstream side is energized against the gate and valve body by the spring and applied pressure acting on an annulus, while the outer seat on the downstream side is energized against the gate by force transferred through the gate from the upstream pressure area.

### CROSS-REFERENCE TO RELATED APPLICATIONS

This application claims priority to U.S. Provisional Application No. 63/774,100, titled “Dual Seat System for Gate Valves”, filed Mar. 19, 2025, which is hereby incorporated by reference in its entirety.

### FIELD OF INVENTION

The present disclosure relates to gate valves for use in oil and gas applications, and more particularly to a dual seat assembly for bidirectional sealing on both sides of a gate valve to reduce fluid flow outside of the flow bore and minimize maintenance requirements.

### BACKGROUND

Gate valves are widely used in the upstream oil and gas sector for controlling fluid flow in high pressure applications. Traditional high pressure gate valves in this sector typically employ downstream sealing configurations, where sealing occurs on the downstream side of the gate relative to the direction of applied pressure. These downstream sealing valves generally require the valve bodies to be filled with grease to slow fluid ingress into the body cavity and to provide lubrication for the moving components. However, such valves allow or require flow and pressure into the body cavity for proper function, which can force out the operating grease over time and lead to erosion of valve components. This results in increased maintenance requirements and reduced valve longevity.

Various approaches have been developed to address sealing in gate valves. Some gate valves utilize expanding or telescopic seats that can be externally energized to create a seal against the gate. Valves with externally energized seats typically require a high preload on the gate and seats to achieve adequate sealing, and the seats must be deenergized before the valve can be operated. This adds complexity to valve operation and may limit the applications in which such valves can be effectively deployed.

Other gate valve designs have emerged that use flow bore pressure to energize the seats. In these pressure-energized seat designs, the flow bore pressure acts on seat surfaces to generate sealing forces against the gate. However, valves with these seats present challenges in balancing the loads applied to the upstream and downstream seats. A high upstream load may be required to seal adequately, but this can result in compounding effects that cause excessive downstream loads. Such excessive downstream loads have been demonstrated to be high enough to crack coatings on the downstream seat or gate surfaces, potentially compromising the seal integrity and valve performance.

Accordingly, there remains a desire for gate valve seat assemblies that can provide effective bidirectional sealing while distributing loads appropriately to both upstream and downstream seats, thereby reducing fluid flow within the valve body outside of the flow bore and minimizing maintenance requirements.

### SUMMARY

This summary is provided to introduce a selection of concepts in a simplified form that are further described below in the detailed description. This summary is not intended to identify key features or essential features of the claimed subject matter, nor is it intended to be used as an aid in determining the scope of the claimed subject matter.

According to an aspect of the present disclosure, a gate valve assembly is provided. The gate valve assembly comprises a valve body defining a flow bore and a gate opening. A gate is disposed within the gate opening and movable between an open position and a closed position. A pair of seat assemblies is disposed within the valve body on opposite sides of the gate. Each seat assembly comprises an inner seat positioned to engage a respective side of the gate and configured to seal against the valve body, an outer seat positioned radially outward of the inner seat and configured to engage the respective side of the gate and to seal against the valve body, and a spring configured to bias the inner seat toward the gate. The inner seat and the outer seat are configured to operate independently such that when the gate is in the closed position and pressure is applied from an upstream side, the inner seat on the upstream side is energized against the gate by the spring and the applied pressure acting on an annulus of the inner seat, and the outer seat on a downstream side is energized against the gate by force transferred through the gate from the upstream pressure area. If cavity pressure is present the outer seat on the downstream side will become energized. Forces transferred to the outer seat on the downstream side are reacted on by contact with the body.

According to another aspect of the present disclosure, a seat assembly for a gate valve is provided. The seat assembly comprises an inner seat having an annular sealing surface configured to engage a gate of the gate valve and a body sealing surface configured to seal against a valve body. An outer seat is disposed radially outward of the inner seat and has an annular sealing surface configured to engage the gate and a body sealing surface configured to seal against the valve body. A spring is configured to bias the inner seat toward the gate. The inner seat and the outer seat are captured within a body pocket of the gate valve and are configured to move independently of each other such that flow bore pressure acting on an annulus of the inner seat energizes the inner seat against the gate and the valve body when the seat assembly is on an upstream side of the gate, and force transferred through the gate from the upstream pressure area energizes the outer seat against the gate when the seat assembly is on a downstream side of the gate. If cavity pressure is present the outer seat on the downstream side will become energized. Forces transferred to the outer seat on the downstream side are reacted on by contact with the body.

According to another aspect of the present disclosure, a method of sealing a gate valve is provided. The method comprises providing a gate valve having a valve body, a gate movable between an open position and a closed position, and a pair of seat assemblies disposed on opposite sides of the gate, each seat assembly including an inner seat configured to seal against the gate and the valve body, an outer seat disposed radially outward of the inner seat and configured to seal against the gate and the valve body, and a spring biasing the inner seat toward the gate. The method further comprises closing the gate to the closed position. The method further comprises applying pressure from an upstream side of the gate. The method further comprises energizing the inner seat of an upstream seat assembly against an upstream side of the gate and against the valve body by the spring and the applied pressure acting on an annulus of the inner seat. The method further comprises energizing the outer seat of a downstream seat assembly against a downstream side of the gate by force transferred through the gate from the upstream pressure area acting on the inner seat of the upstream seat assembly. If cavity pressure is present the outer seat on the downstream side will become energized. Forces transferred to the outer seat on the downstream side are reacted on by contact with the body.

The foregoing general description of the illustrative embodiments and the following detailed description thereof are merely exemplary aspects of the teachings of this disclosure and are not restrictive.

### BRIEF DESCRIPTION OF FIGURES

Non-limiting and non-exhaustive examples are described with reference to the following figures.

FIG. 1 illustrates a cross-sectional view of a gate valve including a valve body and seat assemblies, according to aspects of the present disclosure.

FIG. 2 illustrates a detailed cross-sectional view of a dual seat assembly of the gate valve of FIG. 1, according to aspects of the present disclosure.

FIG. 3 illustrates an exploded isometric view of the dual seat assembly of FIG. 2, according to aspects of the present disclosure.

FIG. 4 illustrates a flowchart of a method of sealing a gate valve, according to aspects of the present disclosure.

### DETAILED DESCRIPTION

The following description sets forth exemplary aspects of the present disclosure. It should be recognized, however, that such description is not intended as a limitation on the scope of the present disclosure. Rather, the description also encompasses combinations and modifications to those exemplary aspects described herein.

The present disclosure relates to a gate valve assembly configured to provide bidirectional sealing. In some cases, the gate valve assembly may include seat assemblies that provide simultaneous sealing on both an upstream side and a downstream side of a gate. The gate valve assembly may address challenges associated with conventional high pressure gate valves used in upstream oil and gas applications.

Conventional gate valves in the upstream oil and gas sector may be downstream sealing, which may require valve bodies to be filled with grease to slow fluid ingress and provide lubrication. Such conventional valves may allow or require flow and pressure into the valve body for proper function. Flow in downstream sealing valve bodies may force out operating grease and erode the valve over time.

Other conventional gate valves may include expanding or telescopic seats that can be externally energized. Valves with externally energized seats may require a high preload on the gate and seats to seal and may need to be deenergized to operate. Still other conventional gate valves may use flow bore pressure to energize seats. Valves with such seats may require a challenging balance of high upstream load to seal adequately without exceeding maximum allowable downstream load due to compounding effects. Such downstream loads have been demonstrated to be high enough to crack coatings on downstream seats or gates.

The gate valve assembly of the present disclosure may distribute high load applied to a downstream seat while maintaining adequate sealing load on an upstream seat. In some cases, the gate valve assembly may substantially reduce fluid flow within the valve body, thereby resulting in a valve with reduced maintenance requirements. The gate valve assembly may include inner and outer dual seats that function independently to form simultaneous sealing on both sides of the gate according to valve position and pressure applied. In some cases, the inner and outer dual seats may function independently and may generate and distribute loads for sealing.

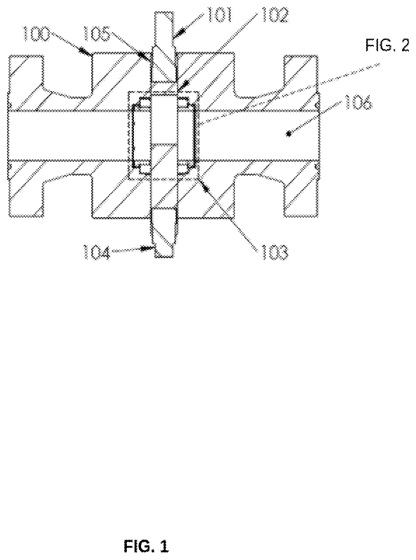

Referring to FIG. 1, a cross-sectional view of a gate valve assembly is shown. The gate valve assembly may include a valve body 100 defining a flow bore 106 and a gate opening 105. The gate opening 105 may be sufficient to allow translational movement of a gate 102 disposed within the gate opening 105. The gate 102 may be movable between an open position and a closed position. In some cases, the gate valve assembly shown in FIG. 1 is depicted in a partially open position for drawing clarity.

With continued reference to FIG. 1, the gate valve assembly may include an operating stem 101 connected to the gate 102 and configured to move the gate 102 between the open position and the closed position. The gate valve assembly may further include a balance stem 104 connected to the gate 102 on an opposite side from the operating stem 101. The operating stem 101 and the balance stem 104 may cooperate to provide translational movement of the gate 102 for opening and closing the gate valve assembly.

As further shown in FIG. 1, a pair of seat assemblies 103 may be disposed within the valve body 100 on opposite sides of the gate 102. The valve body 100 may define a pair of body pockets configured to receive the seat assemblies 103 concentrically with the flow bore 106. In some cases, the seat assemblies 103 may be received within the body pockets such that the seat assemblies 103 are positioned concentrically with the flow bore 106. The upstream and downstream sides of the gate valve assembly may be identified by the direction of flow, where the upstream side is the entry or higher pressure side and the downstream side is the exit or lower pressure side.

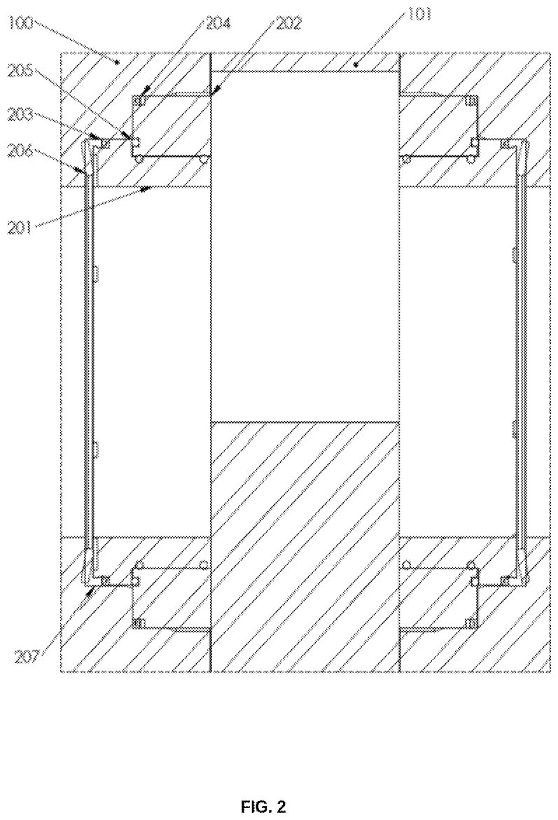

Referring to FIG. 2, a detailed cross-sectional view of the dual seat assembly of the gate valve assembly is shown. Each seat assembly 103 may include an inner seat 201 positioned to engage a respective side of the gate 102. The inner seat 201 may have an annular sealing surface configured to engage the gate 102. Each seat assembly 103 may further include an outer seat 202 positioned radially outward of the inner seat 201 and configured to engage the respective side of the gate 102. The outer seat 202 may have an annular sealing surface configured to engage the gate 102.

With continued reference to FIG. 2, the valve body 100 may define a pair of body pockets 207 configured to receive the seat assemblies 103 concentrically with the flow bore 106. The inner seat 201 and the outer seat 202 of each seat assembly 103 may be captured within the respective body pocket 207 and may be configured to move independently of each other. In some cases, the inner seat 201 and the outer seat 202 are captured but operate fully independently within the valve body 100. The independent movement of the inner seat 201 and the outer seat 202 may allow the inner seat 201 to seal against both the gate 102 and the valve body 100 when the seat assembly 103 is on an upstream side of the gate 102, and may allow the outer seat 202 to seal against both the gate 102 and the valve body 100 when the seat assembly 103 is on a downstream side of the gate 102.

As further shown in FIG. 2, each seat assembly 103 may include a spring 206 configured to bias the inner seat 201 toward the gate 102. The spring 206 may provide an initial energization force to press the inner seat 201 against the gate 102. Each seat assembly 103 may further include a seal 203 disposed between the inner seat 201 and the outer seat 202. The inner seat 201 may include a nonmetallic seal configured to seal against the valve body 100 when the seat assembly 103 is on an upstream side of the gate 102. The outer seat 202 may include a nonmetallic seal on an outer diameter of the outer seat 202 configured to seal against the valve body 100 when the seat assembly 103 is on a downstream side of the gate 102 and pressure exists in a gate cavity.

With continued reference to FIG. 2, each seat assembly 103 may further include at least one trash seal 205 configured to limit contaminants from entering the seat assembly 103. In some cases, the at least one trash seal 205 may be positioned between the inner seat 201 and the outer seat 202. The trash seals 205 may prevent debris and other contaminants from interfering with the operation of the inner seat 201 and the outer seat 202. Each seat assembly 103 may also include an insert 204 disposed within the seat assembly 103. The insert 204 may provide structural support or facilitate proper positioning of components within the seat assembly 103.

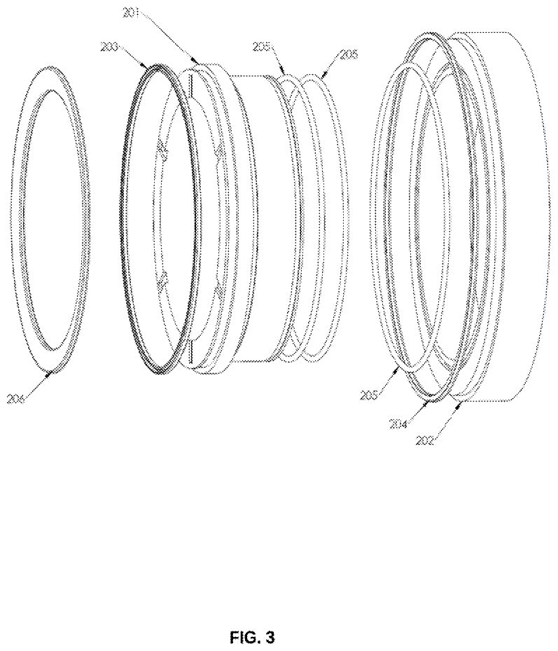

Referring to FIG. 3, an exploded isometric view of the dual seat assembly is shown. The components of the seat assembly 103 are shown disassembled to illustrate how the components nest concentrically within the assembly. The seat assembly 103 may include the inner seat 201, the outer seat 202, the seal 203, the insert 204, the trash seals 205, and the spring 206. These components may be arranged to nest concentrically such that the inner seat 201 is positioned radially inward of the outer seat 202.

With continued reference to FIG. 3, the outer seat 202 may have a larger bearing area configured to engage the gate 102 than the inner seat 201. The larger bearing area of the outer seat 202 may allow sealing load on the downstream side to be distributed over the larger bearing area. In some cases, the distribution of sealing load over the larger bearing area of the outer seat 202 may reduce localized stress on the gate 102 and the outer seat 202 when the seat assembly 103 is on the downstream side. The system may distribute the high load applied to the downstream seat while maintaining adequate sealing load on the upstream seat.

As further shown in FIG. 3, the insert 204 may be disposed within the seat assembly 103. The insert 204 may be positioned concentrically with the inner seat 201 and the outer seat 202. The spring 206 may be positioned to provide the initial energization force to press the inner seat 201 against the gate 102. The trash seals 205 may be positioned within the seat assembly 103 to limit contaminants from entering the seat assembly 103. The concentric arrangement of the inner seat 201, the outer seat 202, the seal 203, the insert 204, the trash seals 205, and the spring 206 may allow the seat assembly 103 to be received within the body pocket 207 of the valve body 100.

When the gate is in the closed position and pressure is applied from an upstream side, the inner seat and the outer seat may be configured to operate independently to provide sealing on both sides of the gate. The spring may be configured to initialize energization of the inner seat onto the gate prior to application of flow bore pressure. The spring may provide an initial biasing force that presses the inner seat against the gate before any pressure is present in the flow bore.

Pressure in the flow bore may act on an annulus of the upstream inner seat, increasing the force on the gate. The annulus may be an exposed annular surface area of the inner seat that is subject to flow bore pressure. Force on the inner seat may be caused by the spring and pressure on the annulus when the valve is closed. The inner seat on the upstream side may thus be energized against the gate by the spring and the applied pressure acting on the annulus of the inner seat. The inner seat on the upstream side may also seal against the valve body via a nonmetallic seal. The combination of spring force and annulus pressure may provide adequate sealing load on the upstream side of the gate, creating a metal-to-metal seal between the inner seat and the gate and a nonmetallic seal between the inner seat and the valve body.

The outer seat on the upstream side may be captured but free to move and does not contribute to sealing on the upstream side when the gate is in the closed position and pressure is applied from the upstream side. The outer seat on the upstream side may remain in a non-sealing state while the inner seat on the upstream side provides the sealing function against both the gate and the valve body.

On the downstream side, the outer seat may be energized against the gate by force transferred through the gate from the full upstream pressure area. The upstream pressure acts on the full diameter pressure area of the upstream inner seat, creating a high load that is transferred through the gate to the downstream outer seat. This high load causes a metal-to-metal seal between the downstream side of the gate and the outer seat. With a larger bearing area, the outer seat can distribute the high loading that has been transferred from the gate to the body without damage. The outer seat on the downstream side may also seal against the valve body via a nonmetallic seal on the outer diameter of the outer seat when pressure has built up in the gate cavity.

The inner seat on the downstream side may be only lightly loaded by the spring force and does not contribute to sealing when the valve is closed. The spring may provide a light biasing force on the downstream inner seat, but the sealing function on the downstream side may be performed by the outer seat against both the gate and the valve body. Seals may be formed between the inner seat and the valve body on the upstream side and between the outer seat and the valve body on the downstream side, based on the pressure within the flow bore and the gate cavity.

When the gate is in the open position, the springs of both seat assemblies may bias the respective inner seats against the gate. The spring force may provide an initial energization that maintains contact between the inner seats and the gate surfaces during open position operation. Flow bore pressure may increase energization of both inner seats through annulus pressure when the gate is in the open position. The pressure acting on the annulus of each inner seat may supplement the spring force to maintain sealing contact between the inner seats and the gate.

Both outer seats may be free when the valve is open and do not contribute to sealing during open position operation. The outer seats may remain in a captured but non-energized state while the inner seats provide the sealing function when the gate is in the open position. The independent operation of the inner seats and the outer seats may allow the seat assemblies to adapt to different valve positions and pressure conditions.

The dual seat system may substantially reduce fluid flow within the valve body, thereby resulting in a valve with reduced maintenance requirements. By providing simultaneous sealing on both the upstream side and the downstream side of the gate, the dual seat system may limit fluid flow outside of the flow bore. The reduction in fluid flow within the valve body may decrease erosion and wear on valve components.

Seals may be formed between the seats and the valve body in either direction based on pressure within the flow bore. The bidirectional sealing capability may eliminate the requirement for valve bodies to be filled with grease to slow fluid ingress and provide lubrication. Traditional high pressure gate valves may require bodies to be filled with grease to slow fluid ingress and provide lubrication, whereas the disclosed dual seat system may eliminate this requirement. The elimination of grease filling requirements may reduce maintenance intervals and operating costs associated with the gate valve assembly.

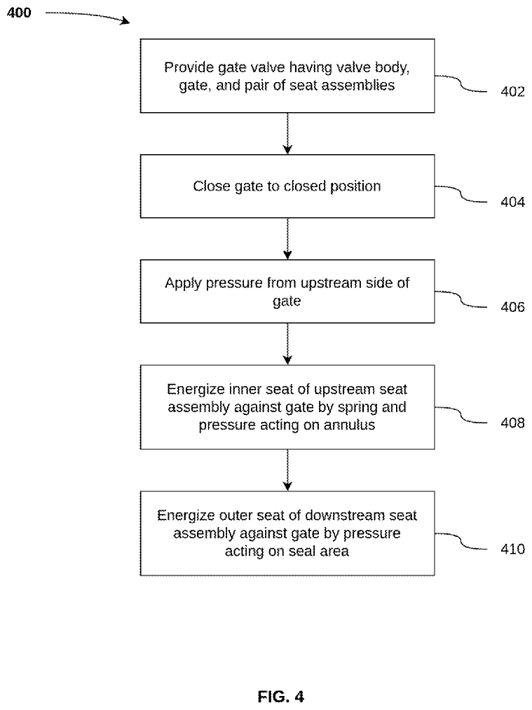

Referring to FIG. 4, a flowchart of a method 400 of sealing a gate valve is shown. The method 400 may include a series of steps for providing bidirectional sealing using the dual seat system described herein.

The method 400 may begin with a step 402 of providing a gate valve having the valve body 100, the gate 102 movable between an open position and a closed position, and a pair of seat assemblies 103 disposed on opposite sides of the gate 102. As described previously, each seat assembly 103 may include the inner seat 201, the outer seat 202 disposed radially outward of the inner seat 201, and the spring 206 biasing the inner seat 201 toward the gate 102. The gate valve provided in step 402 may be configured as described with reference to FIGS. 1-3.

With continued reference to FIG. 4, the method 400 may proceed to a step 404 of closing the gate 102 to the closed position. The gate 102 may be moved from the open position to the closed position using the operating stem 101 and the balance stem 104. In the closed position, the gate 102 may block flow through the flow bore 106.

The method 400 may continue to a step 406 of applying pressure from an upstream side of the gate 102. The upstream side may be the entry or higher pressure side of the gate valve. The applied pressure may act on the seat assemblies 103 disposed on both sides of the gate 102.

As further shown in FIG. 4, the method 400 may then proceed to a step 408 of energizing the inner seat 201 of an upstream seat assembly 103 against an upstream side of the gate 102 and against the valve body 100 by the spring 206 and the applied pressure acting on an annulus of the inner seat 201. The spring 206 may provide an initial biasing force, and the applied pressure acting on the annulus may increase the force pressing the inner seat 201 against the gate 102. The inner seat 201 may form a metal-to-metal seal with the gate 102 and a nonmetallic seal with the valve body 100.

The method 400 may conclude with a step 410 of energizing the outer seat 202 of a downstream seat assembly 103 against a downstream side of the gate 102 by force transferred through the gate 102 from the upstream pressure area acting on the inner seat 201 of the upstream seat assembly 103. The upstream pressure acts on the full diameter pressure area of the upstream inner seat 201, creating a high load that is transferred through the gate 102 to the downstream outer seat 202. This high load causes a metal-to-metal seal between the gate 102 and the outer seat 202. The outer seat 202 may also seal against the valve body 100 via a nonmetallic seal on the outer diameter of the outer seat 202 when pressure exists in the gate cavity.

During the method 400, the outer seat 202 on the upstream side may be captured but free to move and does not contribute to sealing on the upstream side when the gate 102 is in the closed position and pressure is applied from the upstream side. The outer seat 202 of the downstream seat assembly 103 may have a larger bearing area against the gate 102 than the inner seat 201, such that the high load transferred through the gate 102 from the upstream pressure area is distributed over the larger bearing area. The distribution of the high load over the larger bearing area may prevent damage to the gate 102 and the outer seat 202.

The method 400 may further include reducing fluid flow within the valve body 100 outside of the flow bore 106 by simultaneously sealing on both the upstream side and the downstream side of the gate 102. The simultaneous sealing provided by the inner seat 201 sealing against both the gate 102 and the valve body 100 on the upstream side, and the outer seat 202 sealing against both the gate 102 and the valve body 100 on the downstream side, may limit fluid ingress into the valve body 100 and may reduce maintenance requirements associated with the gate valve.

A number of implementations have been described. Nevertheless, it will be understood that various modifications may be made without departing from the spirit and scope of the disclosure. Accordingly, other implementations are within the scope of the following claims.

1. A gate valve assembly, comprising:
a valve body defining a flow bore and a gate opening;
a gate disposed within the gate opening and movable between an open position and a closed position; and
a pair of seat assemblies disposed within the valve body on opposite sides of the gate, each seat assembly comprising:
an inner seat positioned to engage a respective side of the gate and configured to seal against the valve body;
an outer seat positioned radially outward of the inner seat and configured to engage the respective side of the gate and to seal against the valve body; and
a spring configured to bias the inner seat toward the gate;
wherein the inner seat and the outer seat are configured to operate independently such that when the gate is in the closed position and pressure is applied from an upstream side, the inner seat on the upstream side is energized against the gate and the valve body by the spring and the applied pressure acting on an annulus of the inner seat, and the outer seat on a downstream side is energized against the gate by force transferred through the gate from the upstream pressure area.

2. The gate valve assembly of claim 1, wherein the force transferred through the gate from the upstream pressure area acts on a full diameter pressure area of the inner seat on the upstream side, creating a high load that is transferred through the gate to the outer seat on the downstream side.

3. The gate valve assembly of claim 1, wherein the outer seat on the downstream side is configured to seal against the valve body via a nonmetallic seal on an outer diameter of the outer seat when pressure exists in a gate cavity.

4. The gate valve assembly of claim 1, wherein each seat assembly further comprises at least one trash seal configured to limit contaminants from entering the seat assembly.

5. The gate valve assembly of claim 1, wherein the valve body defines a pair of body pockets configured to receive the seat assemblies concentrically with the flow bore.

6. The gate valve assembly of claim 5, wherein the inner seat and the outer seat of each seat assembly are captured within the respective body pocket and are configured to move independently of each other.

7. The gate valve assembly of claim 1, wherein the outer seat on the upstream side is captured but free to move and does not contribute to sealing when the gate is in the closed position and pressure is applied from the upstream side.

8. The gate valve assembly of claim 1, wherein when the gate is in the open position, the springs of both seat assemblies bias the respective inner seats against the gate, and flow bore pressure acting on an annulus of each inner seat increases energization of both inner seats.

9. The gate valve assembly of claim 1, further comprising:
an operating stem connected to the gate and configured to move the gate between the open position and the closed position; and
a balance stem connected to the gate on an opposite side from the operating stem.

10. The gate valve assembly of claim 1, wherein the outer seat has a larger bearing area against the gate than the inner seat.

11. A seat assembly for a gate valve, comprising:
an inner seat having an annular sealing surface configured to engage a gate of the gate valve and a body sealing surface configured to seal against a valve body of the gate valve;
an outer seat disposed radially outward of the inner seat and having an annular sealing surface configured to engage the gate and a body sealing surface configured to seal against the valve body; and
a spring configured to bias the inner seat toward the gate;
wherein the inner seat and the outer seat are captured within a body pocket of the gate valve and are configured to move independently of each other such that flow bore pressure acting on an annulus of the inner seat energizes the inner seat against the gate and the valve body when the seat assembly is on an upstream side of the gate, and force transferred through the gate from the upstream pressure area energizes the outer seat against the gate when the seat assembly is on a downstream side of the gate.

12. The seat assembly of claim 11, further comprising at least one trash seal configured to limit contaminants from entering the seat assembly.

13. The seat assembly of claim 12, wherein the at least one trash seal is positioned between the inner seat and the outer seat.

14. The seat assembly of claim 11, wherein the outer seat has a larger bearing area configured to engage the gate than the inner seat, such that a high load transferred through the gate from the upstream pressure area is distributed over the larger bearing area.

15. The seat assembly of claim 11, further comprising an insert disposed within the seat assembly.

16. The seat assembly of claim 11, wherein the spring is configured to initialize energization of the inner seat onto the gate prior to application of flow bore pressure.

17. A method of sealing a gate valve, comprising:
providing a gate valve having a valve body, a gate movable between an open position and a closed position, and a pair of seat assemblies disposed on opposite sides of the gate, each seat assembly including an inner seat configured to seal against the gate and the valve body, an outer seat disposed radially outward of the inner seat and configured to seal against the gate and the valve body, and a spring biasing the inner seat toward the gate;
closing the gate to the closed position;
applying pressure from an upstream side of the gate;
energizing the inner seat of an upstream seat assembly against an upstream side of the gate and against the valve body by the spring and the applied pressure acting on an annulus of the inner seat; and
energizing the outer seat of a downstream seat assembly against a downstream side of the gate by force transferred through the gate from the upstream pressure area acting on the inner seat of the upstream seat assembly.

18. The method of claim 17, wherein the outer seat on the upstream side is captured but free to move and does not contribute to sealing when the gate is in the closed position and pressure is applied from the upstream side.

19. The method of claim 17, wherein the outer seat of the downstream seat assembly has a larger bearing area against the gate than the inner seat, such that a high load transferred through the gate from the upstream pressure area is distributed over the larger bearing area.

20. The method of claim 19, further comprising reducing fluid flow within the valve body outside of the flow bore by simultaneously sealing on both the upstream side and the downstream side of the gate.
